(19) United States
(12) Patent Application Publication
(10) Pub. No.: US 2018/0074452 A1
(43) Pub. Date: Mar. 15, 2018

(54) PROCESS CARTRIDGE AND IMAGE FORMING APPARATUS

(71) Applicants: Minoru TOYODA, Kanagawa (JP); Kenji NAKAMURA, Kanagawa (JP); Takeru MURAMATSU, Kanagawa (JP); Tomohiro KUBOTA, Kanagawa (JP)

(72) Inventors: Minoru TOYODA, Kanagawa (JP); Kenji NAKAMURA, Kanagawa (JP); Takeru MURAMATSU, Kanagawa (JP); Tomohiro KUBOTA, Kanagawa (JP)

(21) Appl. No.: 15/684,986

(22) Filed: Aug. 24, 2017

(30) Foreign Application Priority Data
Sep. 14, 2016 (JP) 2016-179887

(51) Int. Cl. G03G 21/00

(52) U.S. Cl. CPC G03G 21/0029; G03G 21/1666; G03G 21/1821; G03G 2221/0057; G03G 2215/0409; G03G 21/0082

(57) ABSTRACT

A process cartridge for an image forming apparatus includes an image bearer; a developer bearer to supply a latent image on the image bearer with toner and develop the latent image, a cleaner to clean residual toner on the image bearer after a transfer process, and an elastically deformable remover to contact an end portion of the image bearer in an axial direction of the image bearer. The remover includes an inclined part extending in the axial direction of the image bearer from an upstream side to a downstream side in a direction of movement of the image bearer. The inclined part includes a contact portion to contact the image bearer. The contact portion of the inclined part forms a gradient in the axial direction.

### CROSS-REFERENCE TO RELATED APPLICATION

This patent application is based on and claims priority pursuant to 35 U.S.C. § 119(a) to Japanese Patent Application No. 2016-179887, filed on Sep. 14, 2016 in the Japanese Patent Office, the entire disclosure of which is hereby incorporated by reference herein.

### BACKGROUND

### Technical Field

Embodiments of the present disclosure generally relate to a process cartridge and an image forming apparatus, such as a copier, a printer, a facsimile machine, or a multifunction peripheral (MFP) having at least two of copying, printing, facsimile transmission, plotting, and scanning capabilities.

### Background Art

In an image forming apparatus employing an electrophotographic method that uses toner (for example, a copier, a printer, etc.), toner and free material from the toner (for example, silica) may adhere to and stick to a surface of a photoconductor serving as an image bearer. In particular, both end portions of a developing roller that faces the photoconductor in a developing device are rotated in abutting contact with seal members as toner scattering preventing members, and frictional heat and force caused by the rotation affects end portions of the photoconductor. Thus, toner and free material from toner (for example, silica) becomes an adhered substance that adheres to and sticks to the end portions of the surface of the photoconductor facing the end portions of the developing roller.

Cleaning the adhered substance from the surface of the photoconductor using a remover is known. The remover is typically made of fiber, lubber, and the like, abuts the photoconductor, and removes the adhered substance.

### SUMMARY

This specification describes an improved process cartridge for an image forming apparatus. In one illustrative embodiment, the process cartridge includes an image bearer, a developer bearer to supply a latent image on the image bearer with toner and develop the latent image, a cleaner to clean residual toner on the image bearer after a transfer process, and a remover to contact on a proximity of an end portion of the image bearer in an axial direction of the image bearer, and remove a substance adhered on the image bearer. The remover includes an inclined part extending in the axial direction from an upstream side to a downstream side in a direction of movement of the image bearer. The inclined part includes a contact portion to contact the image bearer. The contact portion of the inclined part forms a gradient in the axial direction.

In another embodiment, an image forming apparatus incorporates the process cartridge described above.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic diagram illustrating a configuration of an image forming apparatus according to an embodiment of the present disclosure;

FIG. 2 is a schematic view illustrating a configuration of main parts in a process cartridge according to a comparative example;

FIG. 3 is a schematic view illustrating the configuration of the process cartridge in a longitudinal direction according to the comparative example;

FIG. 4A is a perspective view from behind and obliquely below an adhered substance remover according to the comparative example;

FIG. 4B is a bottom view of the adhered substance remover according to the comparative example, which is seen from a photoconductor side;

FIG. 4C is an elevation view of the adhered substance remover according to the comparative example, which is seen in a direction of arrow A in FIG. 4A;

FIG. 5 is an elevation view of an adhered substance remover according to a first embodiment;

FIG. 6A is a plan view schematically illustrating an operation of the adhered substance remover according to the comparative example;

FIG. 6B is a cross-sectional view taken along a line A1-A1 in FIG. 6A;

FIG. 6C is a plan view schematically illustrating an operation of the adhered substance remover according to the first embodiment;

FIG. 6D is a cross-sectional view taken along a line A1-A1 in FIG. 6C;

FIG. 7A is an elevation view of an adhered substance remover according to a first modification;

FIG. 7B is an enlarged explanatory diagram illustrating a part D of FIG. 7A;

FIG. 8A is a plan view schematically illustrating an operation of an adhered substance remover according to a second modification;

FIG. 8B is an enlarged cross-sectional view taken along a line A2-A2 in FIG. 8A;

FIG. 8C is an enlarged cross-sectional view taken along a line A3-A3 in FIG. 8A;

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

With reference to drawings, a description is precisely provided of an embodiment of the present disclosure including examples. In each of the embodiments and examples, a part or a component having the same function or shape is applied with the same reference numeral as long as it can be identified, and once explained, a redundant description thereof is omitted.

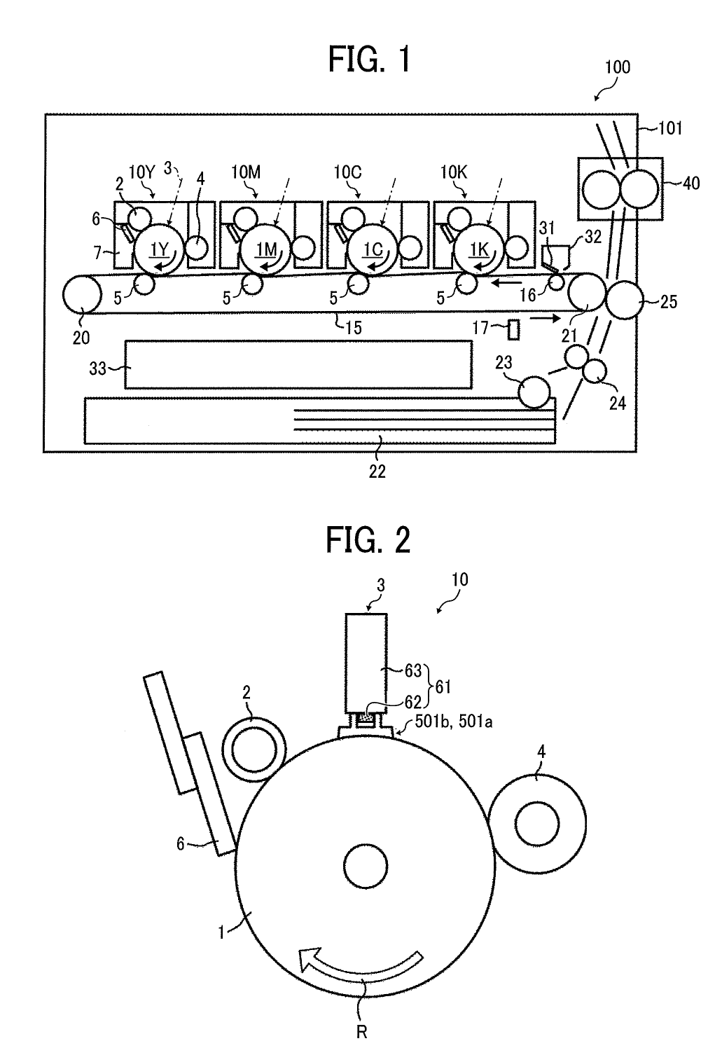

With reference to FIG. 1, descriptions are given below of a configuration and operation of an image forming apparatus 100 according to an embodiment of the present disclosure. FIG. 1 is a schematic diagram illustrating the configuration of the image forming apparatus 100 according to the present embodiment. As illustrated in FIG. 1, the image forming apparatus 100 includes four process cartridges 10Y, 10M, 10C, and 10K serving as an image forming section, which are arranged side by side in this order from left to right and located at the center portion of an apparatus body 101. The process cartridges 10Y, 10M, 10C, and 10K include drum-shaped photoconductors 1Y, 1M, 1C, and 1K serving as image bearers. Yellow toner images, magenta toner images, cyan toner images, and black toner images are formed on the photoconductors 1Y, 1M, 1C, and 1K, respectively.

Because the process cartridges 10Y, 10M, 10C, and 10K are configured similarly and are different in only color of toner used as a developer and the toner image formed in each process cartridge, in the following explanation of the process cartridges, the process cartridges 10Y, 10M, 10C, and 10K are explained as the process cartridge 10 omitted reference numerals representing the colors. Similarly, the photoconductors 1Y, 1M, 1C, and 1K are explained as the photoconductor 1 omitted the reference numerals representing the colors.

The process cartridge 10 includes the photoconductor 1, a charging roller 2 that configures a charging device as a charger, an exposure device 3 as a latent image forming unit, a cleaning blade 6 of a cleaning device 7 as a cleaner, and a developing roller 4 of a developing device as a developing means. The process cartridge 10 is also called a process unit, guided by a unit frame that supports parts and devices of the process cartridge 10, and configured to be detachably mountable relative to the apparatus body 101 of the image forming apparatus 100.

The charging roller 2 is pressed against the outer peripheral surface of the photoconductor 1, rotates with the photoconductor 1, is applied a bias of a direct current (DC) voltage or a bias in which the DC voltage is superimposed on an alternating current (AC) voltage from a high-voltage power source, and charges the surface of the photoconductor 1 uniformly. The exposure device 3 serving as the latent image forming unit exposes image data on the photoconductor 1 to form an electrostatic latent image on the photoconductor 1. The exposure device 3 employs a laser beam scanner with a laser diode or a light emitting diode (LED).

The developing device including a developing roller 4 serving as a developer bearer is a one-component contact developing device and develops the electrostatic latent image on the photoconductor 1 with a predetermined developing bias supplied from the high-voltage power source, into a visualized toner image.

The four process cartridges 10Y, 10M, 10C, and 10K are arranged in parallel and form an yellow, magenta, cyan, and black visible image, respectively, when the image forming apparatus 100 forms a full color image. The visible image formed in each of the four colors is sequentially transferred from the each photoconductor 1 to an intermediate transfer belt 15 contacting the photoconductors 1 and superimposed. Thus, the image forming apparatus 100 forms the full color image.

The intermediate transfer belt 15 is an endless belt disposed under the process cartridges 10 and functions as an intermediate transfer member that bears and carries the toner image as a transferred image. The intermediate transfer belt 15 is entrained about and stretched taut between a drive roller 21 also serving as a secondary-transfer backup roller, a metallic cleaning opposed roller 16, primary-transfer rollers 5, and a driven roller 20 also serving as a tension roller. The intermediate transfer belt 15 is driven to rotate in a direction of arrows along the intermediate transfer belt 15 in FIG. 1 by a drive motor via the drive roller 21. The driven roller 20 as a belt tension device for the intermediate transfer belt 15 is pressed by a spring at both sides of the driven roller 20. In each of both end portions of the driven roller 20, a flange is press-fitted. The flange works as a guide member to control a skew of the intermediate transfer belt 15.

The primary-transfer roller 5 may be a conductive sponge roller or a metal roller. A conductive blade may be used as a primary-transfer part instead of the primary-transfer roller 5. The primary-transfer roller 5 is disposed an offset position that is shifted to upward in a vertical direction and a direction of movement of the intermediate transfer belt 15 from a position at which the intermediate transfer belt 15 contacts the photoconductor 1. A power supply applies a predetermined transfer bias to the primary-transfer roller 5. The transfer bias forms a transfer electric field between the photoconductor 1 and the intermediate transfer belt 15. The transfer electric field transfers the toner image of each color formed on the photoconductor 1 to the intermediate transfer belt 15.

A toner mark sensor 17 includes a regular reflection type sensor and a diffuse reflection type sensor that measure an image density and a position of the toner image in each color on the intermediate transfer belt 15 to control the image density and the position of the toner image in each color. A cleaning unit 32 for the intermediate transfer belt 15 includes a cleaning blade 31 that scrapes residual toner on the intermediate transfer belt 15 after a primary-transfer process to execute a cleaning process for the intermediate transfer belt 15. The cleaning blade 31 made of urethane rubber is disposed opposite the cleaning opposed roller 16 via the intermediate transfer belt 15 and contacts the intermediate transfer belt 15 in a counter direction. Side plates of an intermediate transfer belt unit provided outside both sides of the intermediate transfer belt 15 support rollers between which the intermediate transfer belt 15 is entrained about and stretched taut.

The intermediate transfer belt 15 may be used an endless belt of a resin film, in which conductive material, such as carbon black, is dispersed in poly vinyldene fluoride (PVDF), ethylenetetrafluoroethylene (ETFE), polyimide (PI), polycarbonate (PC), and thermoplastic elastomer (TPE).

The secondary transfer roller 25 is configured with a metal cored bar that is covered by an elastic body with a conductive material. The elastic body of the secondary transfer roller 25 may include an ion conductive material or an electron conductive material.

A sheet feeder is disposed under the intermediate transfer belt 15. The sheet feeder includes a sheet tray to load and store a sheet recording medium or a transfer member such as a sheet and overhead projector (OHP) transparency (hereinafter called a sheet 22). A feed roller 23 and a sheet separator that configure the sheet feeder separate the sheets 22 one by one and feed the sheet 22 to a registration roller 24. The registration roller 24 stops the sheet 22 temporarily and corrects a skew of the sheet 22. Subsequently, the registration roller 24 feeds the sheet 22 to the secondary transfer roller 25 at a timing at which a leading edge of the color toner image or the monochrome image formed on the surface of the intermediate transfer belt 15 reaches a secondary transfer position. The secondary transfer roller 25 is applied a high voltage. A potential difference formed between the secondary transfer roller 25 and the intermediate transfer belt 15 collectively transfers the color toner image or the monochrome image formed on the intermediate transfer belt 15 to the sheet 22.

The sheet 22 is separated from the intermediate transfer belt 15 by curvature of the drive roller (the secondary transfer backup roller) 21 in a vertical paper feeding path. Because the toner image on the sheet 22 is not fixed, a fixing device 40 melts and fixes the toner image on the sheet 22. An output roller pair outputs the sheet 22 fixed the toner image on an output tray on a top of the apparatus body 101

The cleaning blade 31 of the cleaning unit 32 for the intermediate transfer belt 15 scrapes and cleans residual toner remaining on the surface of the intermediate transfer belt 15 after the toner image is transferred to the sheet 22. The scraped residual toner is transported through a toner conveyance passage and stored in a waste toner container for the intermediate transferor 33. A next toner image may be transferred to the cleaned intermediate transfer belt 15.

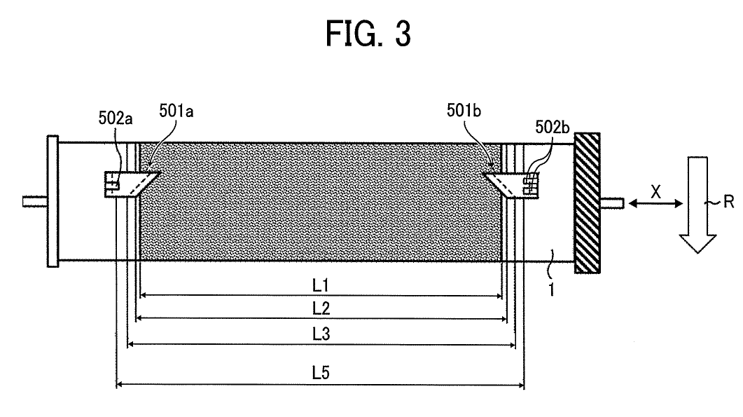

With reference to FIG. 2 and FIG. 3, a description is given below of the process cartridge according to a comparative example.

FIG. 2 is a schematic view illustrating a configuration of main parts in the process cartridge according to the comparative example. FIG. 3 is a schematic view illustrating the configuration of the process cartridge in a longitudinal direction according to the comparative example. It is to be noted that, in FIG. 3, an optical writing head 61 used as the exposure device 3 is omitted to illustrate an adhered substance remover 501 more clearly. As illustrated in FIG. 2, the process cartridge 10 configures the image forming section in which the charging roller 2, the exposure device 3, the developing roller 4 in the developing device, and the cleaning blade 6 in the cleaning device 7 for the photoconductor 1 are disposed in this order in a rotational direction R as a direction of movement of the photoconductor 1. The process cartridge 10 configures a unit that includes the photoconductor 1 and the components disposed therearound, namely, the charging roller 2, the exposure device 3, the developing roller 4, and the cleaning blade 6 and is supported by a common frame. The process cartridge 10 is detachably attached to the image forming apparatus body (hereinafter called the apparatus body 101).

The exposure device 3 uses the optical writing head 61. As schematically illustrated in FIG. 2, the optical writing head 61 is configured by a lens array 62, a substrate for light emitting elements, and a head frame 63 that supports the substrate and the lens array 62. A light emitting diode (LED) array or an organic electro-luminescence (EL) may be used as the light emitting elements for the optical writing head 61 to irradiate the photoconductor 1 with light and form a latent image. Use of the above-described light emitting elements is helpful to configure the compact exposure device 3, make the image forming apparatus smaller, and makes it possible to form the good electrostatic latent image on the photoconductor 1.

The adhered substance removers 501a and 501b are disposed between the photoconductor 1 and the optical writing head 61, and function as spacer parts and regulation members to regulate a distance between the photoconductor 1 and the optical writing head 61 in a radial direction of the photoconductor 1. As illustrated in FIG. 3, the adhered substance removers 501a and 501b are disposed on respective end portions of the photoconductor 1 in an axial direction X of the photoconductor 1 and function as parts to remove the adhered substance that adheres in the proximity of both end portions of the photoconductor 1 corresponding to the maximum sheet width L3 of sheet P used in the image forming apparatus 100 in the axial direction of the photoconductor 1.

The adhered substance remover 501a illustrated on the left of FIG. 3 and a far side of FIG. 2 in a direction perpendicular to the page includes one head contact part 502a including a head contacting surface that contacts a bottom surface of the head frame 63. The adhered substance remover 501b illustrated on the right of FIG. 3 and a front side of FIG. 2 in a direction perpendicular to the page includes two head contact parts 502b including a head contacting surface that contacts a bottom surface of the head frame 63. Thus, a total of three head contacting surfaces of the adhered substance removers 501a and 501b support the optical writing head 61. The adhered substance removers 501a and 501b each include a surface contacting the photoconductor 1, which is precisely described later.

When the bottom surface of the head frame 63 of the optical writing head 61 contacts the three head contact part 502a and 502b of the adhered substance removers 501a and 501b, a pressing member (a head pressing member) such as a compression spring set on the head frame 63 presses the optical writing head 61 with a force that is a load toward the photoconductor 1. The three head contact part 502a and 502b are configured to receive the force. The force is transmitted to a contact surface where the adhered substance removers 501a and 501b contact the photoconductor 1, described later.

The adhered substance removers 501a and 501b include an inclined part extending from the inner side to the outer side in the axial direction X of the photoconductor 1 (hereinafter also referred to as a width direction X) from an upstream side to a downstream side in the rotational direction R of the photoconductor 1. The adhered substance removers 501a and 501b also include a part that contacts the photoconductor 1 inside the width L1 of the maximum image portion being a little bit shorter than the width L2 of the maximum exposure portion in the width direction X of the photoconductor 1. The adhered substance removers 501a and 501b also further include a part that contacts the photoconductor 1 outside the width L3 of the maximum sheet in the width direction X.

The adhered substance on the photoconductor 1 to be removed by the adhered substance removers 501a and 501b is described below. As described in the above background art, both end portions of a developing roller in a developing device are rotated in abutting contact with a seal member as a toner scattering preventing member. Frictional heat and force caused by the rotation affects end portions of the photoconductor that face the end portions of the developing roller. Thus, toner and free material from toner (such as silica) becomes an adhered substance that adheres to and sticks to the end portions of the surface of the photoconductor facing the end portions of the developing roller.

Additionally, ingredients such as talc, etc. from the sheet 22 are easily adhered to the proximity of both end portions of the photoconductor 1 corresponding to the maximum sheet width, that is, the maximum sheet width L3 of the maximum recording medium usable in the image forming apparatus 100 in the axial direction X of the photoconductor 1. The free material (for example Silica) that is easily adhered to the end portions of the surface of the photoconductor facing the end portions of the developing roller and the ingredients such as talc, etc. that is adhered to the end portions of the photoconductor 1 corresponding to the maximum sheet width L3 become the adhered substance that is difficult to remove perfectly by only the cleaning blade 6 in the cleaning device 7 for removing the residual toner on the photoconductor 1. The adhered substance on the photoconductor 1 causes damage on the edge of the cleaning blade 6. The damage causes a cleaning failure that the residual toner is not cleaned. The cleaning failure causes a bad image quality such as a vertical streak and a toner stain in the proximity of end portion of the sheet 22 in the axial direction X of the photoconductor 1.

Therefore, using the rotation of the photoconductor 1 in the rotational direction R, the adhered substance removers 501a and 501b scrape and remove the adhered substance adhered on the photoconductor 1 and discharge the removed substance into a region that does not affect an image quality (that is, outside of the maximum sheet width illustrated in FIG. 3). The rotation of the photoconductor 1 carries the removed substance to the cleaning blade 6. The cleaning blade 6 collects the removed substance because the removed substance exists within a width L5 of the cleaning blade 6 on the photoconductor 1.

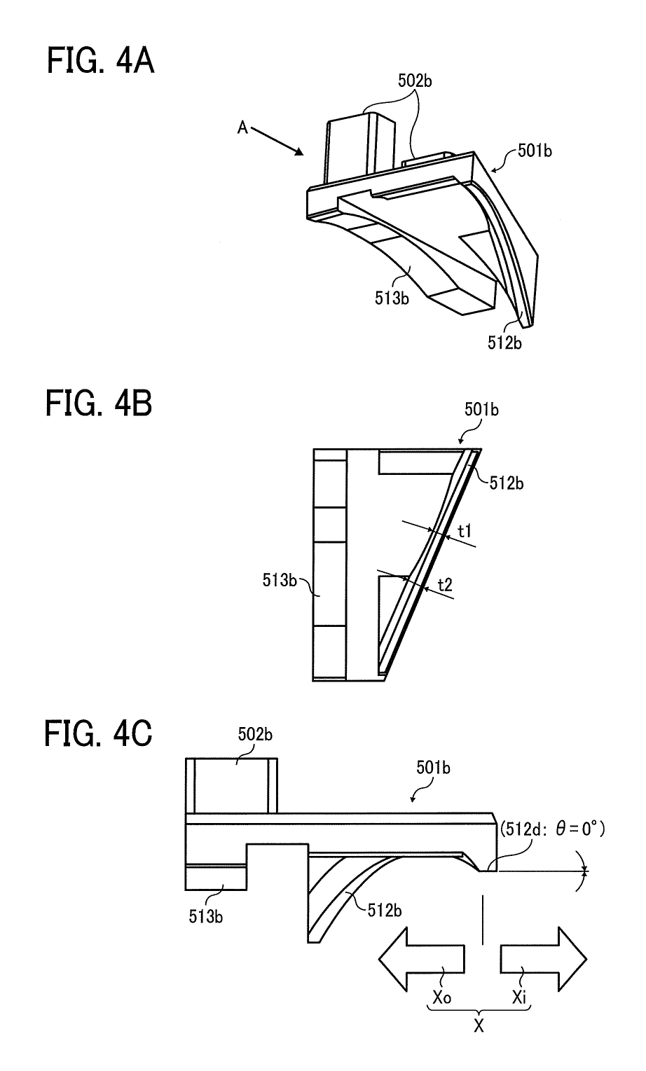

With reference to FIGS. 4A to 4C, a description is given below of the adhered substance remover according to the comparative example. FIGS. 4A to 4C are views illustrating the adhered substance remover 501b according to the comparative example. FIG. 4A is a perspective view from behind and obliquely below the adhered substance remover 501b according to the comparative example. FIG. 4B is a bottom view of the adhered substance remover 501b according to the comparative example, which is seen from a photoconductor 1 side, and illustrates a tip width t1 that is a width of an inclined contact surface 512b and a rib width t2 that is a width of a base of a rib including the inclined contact surface 512b. FIG. 4C is an elevation view of the adhered substance remover 501b according to the comparative example, which is seen in a direction of arrow A in FIG. 4A. As described above, the adhered substance removers 501a and 501b are disposed on the proximity of both end portions of the photoconductor 1 in the axial direction X of the photoconductor 1 and have a figure that is substantially symmetrical in the axial direction X of the photoconductor 1. Therefore, one of them, the adhered substance remover 501b is described as a representative.

The adhered substance remover 501b includes the inclined contact surface 512b that is tabular, inclined with respect to the rotational direction R of the photoconductor 1, and contacts the photoconductor 1 and a parallel contact surface 513b that contacts the photoconductor 1 parallel to the rotational direction R of the photoconductor 1. The inclined contact surface 512b and the parallel contact surface 513b are provided apart from each other and do not intersect.

The inclined contact surface 512b and the parallel contact surface 513b are surfaces formed on tips of the ribs that are formed on a surface of the adhered substance remover 501b. The surface that the ribs are formed is opposite to another surface on which the head contact parts 502b are provided, that is, the surface on the side of the photoconductor 1. The adhered substance remover 501b does not include a rib other than the ribs provided the inclined contact surface 512b and the parallel contact surface 513b. As illustrated in FIG. 4B, in the adhered substance remover 501b, the rib with the inclined contact surface 512b and the rib with the parallel contact surface 513b are provided apart from each other and do not intersect. After the adhered substance remover 501b removes the adhered substance, a configuration in which the two ribs are provided apart from each other enables to avoid accumulation of the removed substance. A configuration in which the two ribs are connected makes it difficult to move the removed substance to the region that does not affect an image quality and may accumulate the removed substance between the inclined contact surface 512b and the parallel contact surface 513b in the adhered substance remover 501b.

As illustrated in FIGS. 4A and 4C, a form of the inclined contact surface 512b that contacts the photoconductor 1 and is formed by cutting the rib includes an arc and inclined form.

Additionally, as illustrated in FIG. 4B, the tip width t1 of a contact part in which the inclined contact surface 512b contacts the photoconductor 1 is smaller than the rib width t2 that is the width of the base of the rib. In this configuration, compared with a configuration in which the tip width t1 equals to the rib width t2, the tip contacting the photoconductor 1 easily deforms elastically and makes close contact with the photoconductor 1.

Because the inclined contact surface 512b and the parallel contact surface 513b do not intersect each other, after the adhered substance remover 501b removes the adhered substance from the photoconductor 1, the removed substance is discharged from the space between the inclined contact surface 512b and the parallel contact surface 513b.

### First Embodiment

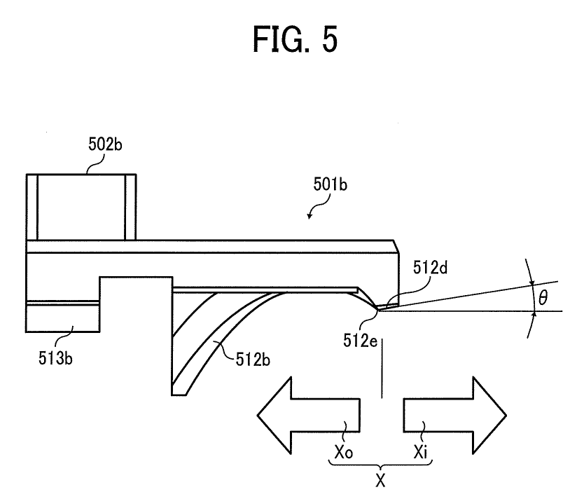

With reference to FIG. 5, a description is given below of an adhered substance remover of a first embodiment according to the present disclosure. FIG. 5 is an elevation view of the adhered substance remover according to the first embodiment. As illustrated in FIG. 3, the two adhered substance removers 501a and 501b of the first embodiment are disposed on the proximity of both end portions of the photoconductor 1 in the axial direction X of the photoconductor 1 and have a figure that is substantially symmetrical in the axial direction X of the photoconductor 1. Therefore, one of them, the adhered substance remover 501b is described as a representative. This is also applied to a first modification and a second modification described hereinafter.

Compared with the adhered substance remover 501b of the comparative example in FIG. 4, the adhered substance remover 501b of the first embodiment illustrated in FIG. 5 differs in that the contact portion of the photoconductor 1 and the inclined contact surface 512b form a gradient 512d that is inclined to the axial direction X of the photoconductor 1.

The adhered substance remover 501b corresponds to a remover of the present disclosure. The inclined contact surface 512b corresponds to an inclined part of the present disclosure. The contact portion on which the inclined contact surface 512b substantially contacts the photoconductor 1 corresponds to a contact portion of the present disclosure.

Specifically, with reference to FIG. 5, the adhered substance remover 501b forms the gradient 512d that is inclined downward toward the left in the drawing in a direction from an inside Xi in the axial direction of the photoconductor 1 to an outside Xo in the axial direction of the photoconductor 1. Therefore, in the outside Xo in the axial direction, the remover 501b firstly contacts the photoconductor 1 with respect to the image portion in the axial direction X.

Material of the remover such as the adhered substance remover 501b according to the present disclosure, including the first modification and the second modification, is polyacetal (POM) resin. Polyacetal (POM) resin exhibits low friction. Use of such material decreases wear of the photoconductor 1 contacting the remover, extends a life of the photoconductor 1, and improves performance of removing the adhered substance and residual toner.

As illustrated with parentheses in FIG. 4C, the adhered substance remover 501b of the comparative example illustrated in FIG. 4C does not include the gradient 512d. Therefore, the angle of the gradient 512d equals zero (θ=0°). Thus, regarding to a contact of the photoconductor 1 and the adhered substance remover 501b, it is not specified which point of the inclined contact surface 512b contacts the photoconductor 1. As a result, the adhered substance remover 501b may not sometimes remove the adhered substance on the photoconductor 1 depending on the surface condition of the inclined contact surface 512b.

By contrast, the adhered substance remover 501b of the first embodiment is inclined with respect to the axial direction X of the photoconductor 1 and thus forms the gradient 512. The gradient 512 provides a point that surely and firstly contacts the photoconductor 1 in the contact portion of the inclined contact surface 512b and the photoconductor 1. As a result, the adhered substance remover 501b of the first embodiment enables to keep a performance removing the adhered substance on the photoconductor 1. There is no need to press the whole of the inclined contact surface 512b with a big force that is enough to deform the inclined contact surface 512b and keep a contact of the photoconductor 1 and the inclined contact surface 512b.

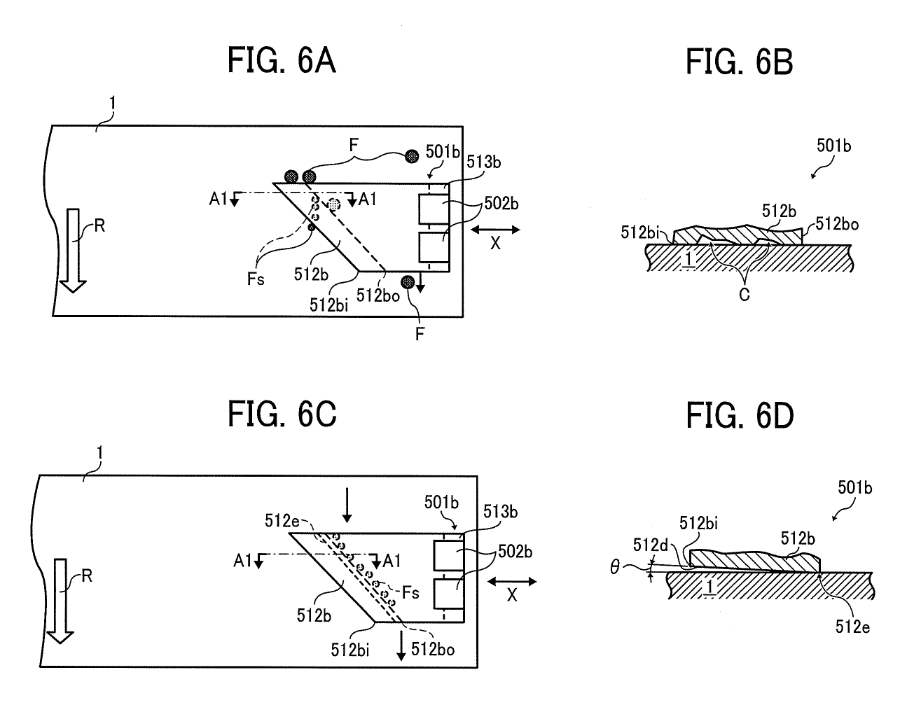

With reference to FIGS. 6A to 6D, a description is given below of an operation of the adhered substance remover 501b of the first embodiment compared with an operation of the adhered substance remover 501b according to the comparative example.

FIG. 6A is a plan view schematically illustrating an operation of the adhered substance remover according to the comparative example. FIG. 6B is a cross-sectional view taken along a line A1-A1 in FIG. 6A FIG. 6C is a plan view schematically illustrating an operation of the adhered substance remover according to the first embodiment. FIG. 6D is a cross-sectional view taken along a line A1-A1 in FIG. 6C. As described above, the two adhered substance removers of the first embodiment and the comparative example are disposed on the proximity of both end portions of the photoconductor 1 in the axial direction X of the photoconductor 1 and have the figure that is substantially symmetrical in the axial direction X of the photoconductor 1. Therefore, one of them on the photoconductor 1, the adhered substance remover 501b (on the right side of FIG. 3) is described as a representative.

As illustrated in FIG. 6A, the photoconductor 1 contacts the inclined contact surface 512b and the parallel contact surface 513b of the adhered substance remover 501b of the comparative example. One side of the inclined contact surface 512b that is inside in the axial direction of the photoconductor 1 is called an inner slant side 512bi. Another side of the inclined contact surface 512b that is outside in the axial direction of the photoconductor 1 is called an outer slant side 512bo. It is preferable that the whole of the inclined contact surface 512b contacts the photoconductor 1 to scrape and remove the adhered substance F such as relatively big residual toner and the like on the photoconductor 1. However, minute irregularities of the inclined contact surface 512b in the order of micrometer and limitation of the force makes it difficult for the photoconductor 1 to contact the whole of the inclined contact surface 512b uniformly and perfectly.

For example, as illustrated in FIG. 6B, the inclined contact surface 512b forms a small gap C in the contact portion of the photoconductor 1 and the inclined contact surface 512b in a cross-section taken along the line A1-A1 in FIG. 6A. It is possible to remove the adhered substance F that is larger than the small gap C regardless of a contact situation of the adhered substance remover 501b and the photoconductor 1. However, there is a case that a minute adhered substance Fs in the order of micrometer is not removed depending on a size of the small gap C. As illustrated in FIG. 6A, the minute adhered substance Fs illustrated by a broken lead line enters the small gap C and pass through the small gap C (the minute adhered substance Fs passed through the small gap C is illustrated by a small black solid circle in FIG. 6A). Thus, the inclined contact surface 512b may not remove the minute adhered substance Fs.

An example of the adhered substance F is toner. An example of the minute adhered substance Fs is a free material from toner (ex. Silica) and an ingredient such as talc, etc. from the sheet 22. The strong force from the adhered substance remover 501b to the photoconductor 1 may perform a uniform contact situation between the inclined contact surface 512b and the photoconductor 1, but increase abrasions of the adhered substance remover 501b and the photoconductor 1, and results in short lives of the adhered substance remover 501b and the photoconductor 1. Therefore, preferably, without being strengthened, the force of the adhered substance remover 501b for the photoconductor 1 performs the stable uniform contact situation.

The adhered substance remover 501b of the first embodiment illustrated in FIG. 6C includes the gradient 512d between the outer slant side 512bo and the inner slant side 512bi in the axial direction X. With reference to FIG. 6D, the gradient 512d causes the outer slant side 512bo to contact the photoconductor 1 firstly and inevitably at a first contact portion 512e and keep the contact situation. As illustrated in FIG. 6C, the minute adhered substance Fs illustrated by a broken lead line is blocked and removed by the first contact portion 512e, and discharged from the space between the inclined contact surface 512b and the parallel contact surface 513b. Thus, a contact of the photoconductor 1 and the first contact portion 512e provided in the adhered substance remover 501b of the first embodiment is more stable than the contact of the photoconductor 1 and the inclined contact surface 512b of the adhered substance remover 501b of the comparative example because the first contact portion 512e firstly and surely contacts the photoconductor 1. Therefore, it is possible for the adhered substance remover 501b of the first embodiment to scrape and remove the adhered substance F including the minute adhered substance Fs stably.

Performing the stable contact of the photoconductor 1 and the adhered substance remover in the first embodiment does not need the increase of the force to the adhered substance remover to decrease the small gap C on the photoconductor 1. The first embodiment performs the more stable contact with the lower force than the comparative example. In the comparative example, when the high force is set to decrease the small gap C, there is probability that the partial abrasion of the photoconductor 1 or the adhered substance remover 501b is speeded up, but, in the first embodiment, performing the stable contact of the photoconductor 1 and the adhered substance remover prevents acceleration of the abrasion.

In the first embodiment, as illustrated in FIG. 5 and FIG. 6D, an angle of the gradient 512d from the outer slant side 512bo to inner slant side 512bi is set θ=5°, but adjustable according to the configuration of the image forming apparatus. Based on the inventor's experiment, the angle of the gradient 512d at the contact portion was preferably set greater than 0° and equal to or smaller than 5°. Setting the angle of the gradient 512d greater than 0° prevents the contact of the photoconductor 1 and the contact portion from becoming plane contact. Setting the angle of the gradient 512d smaller than or equal to 5° makes it easy for the contact portion to deform elastically and contact the photoconductor 1. Setting the angle of the gradient 512d greater than 5° increase the average distance between the gradient 512d and the photoconductor 1 and the force to contact the photoconductor 1.

In the first embodiment, as described above, the adhered substance remover 501b functions as the spacer part and the regulation member to regulate the distance between the photoconductor 1 and the optical writing head 61. The first embodiment like this provides the process cartridge 10 that is small and cost effective and gives stable image quality for a long time because the adhered substance remover 501b serving as the remover works as the regulation member. In other words, the first embodiment decreases a number of parts of the process cartridge 10 (the image forming section) and is helpful for making the image forming apparatus smaller and cost effective.

In the first embodiment, the gradient 512d is provided with the outer slant side 512bo that firstly contacts the photoconductor 1. However, the present disclosure is not limited to this structure. That is, the gradient 512d may be provided with the inner slant side 512bi that firstly contacts the photoconductor 1.

First Modification

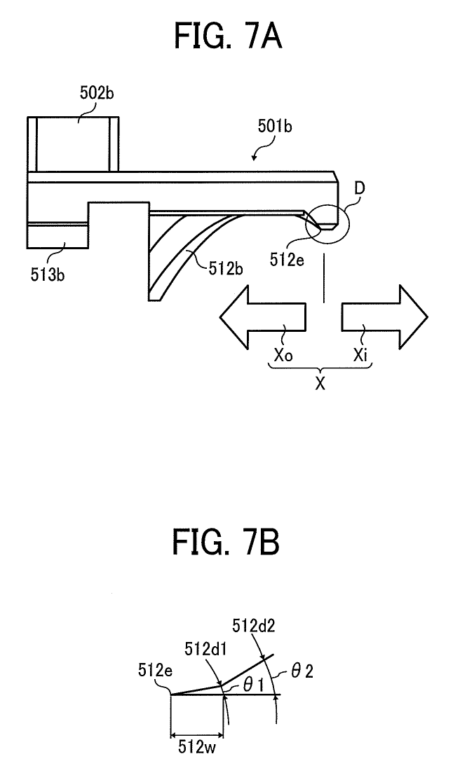

With reference to FIGS. 7A to B, a description is given below of an adhered substance remover according to a first modification of the first embodiment. FIG. 7A is an elevation view of the adhered substance remover according to the first modification. FIG. 7B is an enlarged explanatory diagram illustrating a part D of FIG. 7A.

As illustrated in FIG. 3, the two adhered substance removers 501a and 501b of the first modification are disposed on the proximity of both end portions of the photoconductor 1 in the axial direction X of the photoconductor 1 and have a figure that is substantially symmetrical in the axial direction X of the photoconductor 1. Therefore, one of them, the adhered substance remover 501b is described as a representative. Compared with the adhered substance remover 501b of the first embodiment in FIG. 5, the adhered substance remover 501b of the first modification illustrated in FIG. 7 differs in that the gradient 512d in the axial direction X of the photoconductor 1 on the contact portion of the photoconductor 1 and the inclined contact surface 512b includes a plurality of continuous gradient parts.

The inclined contact surface 512b of the adhered substance remover 501b includes a first gradient 512d1 (an angle θ1) and a second gradient 512d2 (an angle θ2) that continuously connects the first gradient 512dl. The first gradient 512d1 is an elastic contact part 512w that elastically deforms and contacts the photoconductor 1. The inclined contact surface 512b includes such two gradient angles. The elastic contact part 512w (the first gradient 512d1) contacts the photoconductor 1 with a target contact width. Another second gradient 512d2 avoids the contact of the photoconductor 1 and the inclined contact surface 512b. As described above, the first modification enables the inclined contact surface 512b to set a condition of contact with the photoconductor 1 more precisely, and performs the stable contact of the photoconductor 1 and the inclined contact surface 512b. As a result, the first modification provides the process cartridge 10 including the adhered substance remover that scrapes the adhered substance stably.

Second Modification

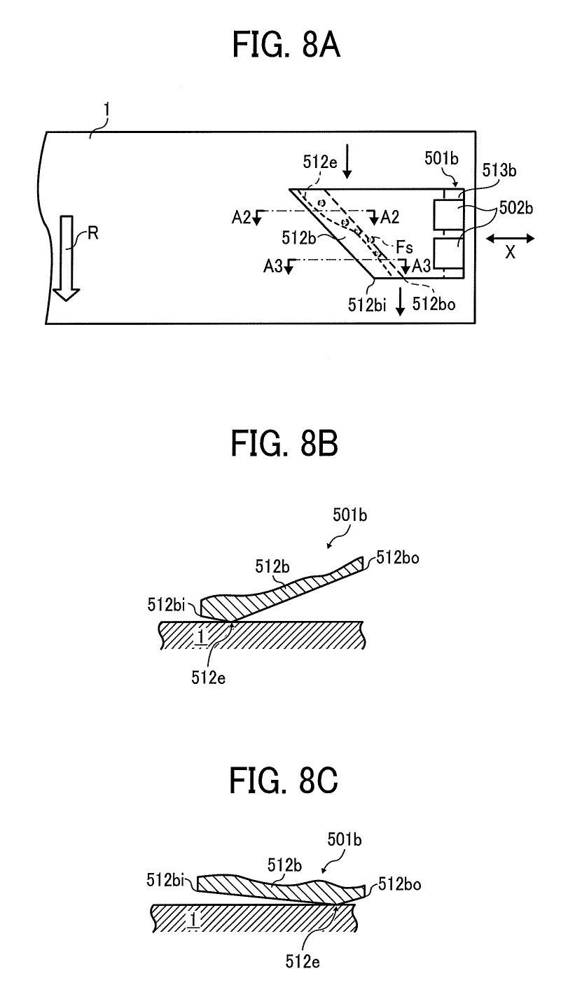

With reference to FIGS. 8A to C, a description is given below of a structure and an operation of an adhered substance remover according to a second modification. FIG. 8A is a plan view schematically illustrating an operation of the adhered substance remover according to the second modification. FIG. 8B is an enlarged cross-sectional view taken along a line A2-A2 in FIG. 8A. FIG. 8C is an enlarged cross-sectional view taken along a line A3-A3 in FIG. 8A. As illustrated in FIG. 3, the two adhered substance removers 501a and 501b of the second modification are disposed on the proximity of both end portions of the photoconductor 1 in the axial direction X of the photoconductor 1 and have a figure that is substantially symmetrical in the axial direction X of the photoconductor 1. Therefore, one of them, the adhered substance remover 501b is described as a representative. Compared with the adhered substance remover 501b of the first embodiment in FIG. 5, the adhered substance remover 501b of the second modification differs in that the first contact portion 512e at which the inclined contact surface 512b contacts the photoconductor 1 is formed from the inner slant side 512bi to the outer slant side 512bo.

The form of the first contact portion 512e formed from the inner slant side 512bi to the outer slant side 512bo, for example, may be configured as a plurality of lines or a curve and need not be configured as a straight line. The first contact portion 512e that contacts the photoconductor 1 is located on the inner slant side 512bi in the enlarged cross-sectional view taken along a line A2-A2 of the FIG. 8B. On the other hand, the first contact portion 512e is located on the outer slant side 512bo in the enlarged cross-sectional view taken along a line A3-A3 of the FIG. 8C. Because an ability to scrape the adhered substance is maintained with such configuration, that is, the configuration in which the first contact portion 512e expands in a downstream side in the rotational direction of the photoconductor 1, the first contact portion may be located in a different position in the cross section surface including the inner slant side 512bi and the outer slant side 512bo.

As described above, it is important that the adhered substance remover keeps the first contact portion on the photoconductor 1 so as not to form the small gap C on the photoconductor 1. Thus, the adhered substance remover of the second modification scrapes and discharges the minute adhered substance on the photoconductor 1.

Based on the above-described operation, the adhered substance remover 501b of the second modification may be restated as follows. The adhered substance remover 501b is pressed toward the photoconductor 1 to contact the photoconductor 1, and configured to be able to deform elastically. Additionally, when the adhered substance remover 501b contacts the photoconductor 1 by being pressed, the first contact portion 512e of which contact portion is considered one line firstly contacts the photoconductor 1 and deforms elastically. After the deformation, the adhered substance remover 501b and the photoconductor 1 become a contact condition.

Furtherly, the adhered substance remover 501b of the second modification may be restated as follows. The adhered substance remover 501b is pressed toward the photoconductor 1 to contact the photoconductor 1, and configured to be able to deform elastically. Additionally, when the adhered substance remover 501b contacts the photoconductor 1 by being pressed, the first contact portion 512e of which contact portion considered a plurality of connected lines firstly contacts the photoconductor 1 and deforms elastically. After the deformation, the adhered substance remover 501b and the photoconductor 1 become the contact condition.

As described above, because the adhered substance remover 501b in the second modification constantly contacts the photoconductor 1, the second modification provides the process cartridge 10 including the adhered substance remover that scrape the adhered substance on the photoconductor stably.

As described above, the adhered substance remover of the first embodiment, the first modification, and the second modification scrapes and discharge the minute adhered substance on the photoconductor 1. Additionally, when the exposure device 3 includes the optical writing head 61, the process cartridge 10 becomes smaller. Therefore, the smaller image forming apparatus 100 is provided.

Although the embodiments of the present disclosure have been described above, the present disclosure is not limited to the embodiments described above, but a variety of modifications can naturally be made within the scope of the present disclosure. For example, the technical features described in the above-described embodiment and examples may be combined as appropriate.

In the present embodiment described above, the image forming apparatus 100 employing an intermediate transfer method and a color tandem system has been described, but the present disclosure is not limited only to such a structure. For example, the present embodiment can adapt to various types of image forming apparatuses such as tandem image forming apparatuses employing a direct transfer method, monochrome or single-color image forming apparatuses, and four rotation method full color image forming apparatuses. Additionally, the present embodiment can adapt to an image forming apparatus not employing the process cartridge 10 but including an image bearer, the adhered substance remover of the present disclosure, a charging device, a developing device, and a cleaning device.

Although the above-described embodiments concern the image forming apparatus 100 including the exposure device 3 using the optical writing head 61 as the exposure means, embodiments of this specification are not limited thereto but also include, for example, image forming apparatuses including exposure devices using a polygon mirror and other exposure means. Although the above-described embodiments concern the image forming apparatus 100 using the drum-shaped photoconductor 1 as the latent image bearer, embodiments of this specification are not limited thereto but also include, for example, image forming apparatuses using endless belt type photoconductors, that is, photoconductor belts. Specifically, the present embodiment can adapt to an image forming apparatus that has a structure in which the adhered substance remover contacts the photoconductor belt supported by rollers.

The above-described effects of the embodiment and the modifications are only examples, and the effects of the present disclosure are not limited to those described in the above-described embodiment and the modifications.

The aforementioned embodiments are examples and specific effects can be obtained for each of the following aspects:

Aspect 1

A process cartridge such as the process cartridge 10 includes an image bearer such as the photoconductor 1, a developer bearer such as the developing roller 4 to supply a latent image on the image bearer with toner and develop the latent image, a cleaner such as the cleaning blade 6 to clean residual toner on the image bearer after the primary transfer process, a remover such as the adhered substance removers 501a and 501b to remove the adhered substance such as the minute adhered substance Fs and the adhered substance F adhered on the image bearer. The remover contacts the image bearer on the proximity of the end portion of the image bearer in an axial direction such as the direction X of the image bearer. The remover includes an inclined part to contact the image bearer, such as the inclined contact surface 512b extending in the axial direction from the upstream side to the downstream side in a direction of movement such as the rotational direction R of the image bearer. The inclined part includes a contact portion to contact the image bearer. The contact portion of the inclined part forms a gradient in the axial direction, such as the gradient 512d.

According to Aspect 1, as described in the above-described first embodiment, for example, the following peculiar advantage can be obtained. The aspect 1 makes it possible to provide the process cartridge in which the adhered substance including the minute adhered substance on the image bearer is removable because the simple configuration enables the remover to contact the image bearer stably.

Aspect 2

In the aspect 1, the gradient in the axial direction of the contact portion of the remover such as the adhered substance removers 501a and 501b includes a plurality of continuous gradients such as the first gradient 512d1 and the second gradient 512d2. As described in the first modification described above, the aspect 2 provides the process cartridge including the remover that scrape the adhered substance stably because the aspect 2 enables the inclined contact surface to set a condition of contact with the image bearer more precisely, and performs a stable contact of the image bearer and the inclined contact surface.

Aspect 3

In the process cartridge according to the aspect 1, the remover such as the adhered substance removers 501a and 501b is elastically deformable, and configured to be pressed toward the image bearer to contact the image bearer by a pressing member such as a compression spring in the image forming apparatus or the process cartridge. Additionally, when the remover contacts the image bearer by being pressed, the first contact portion 512e of which contact portion is considered one line firstly contacts the image bearer, and deforms elastically. After the deformation, the remover and the image bearer become a contact condition.

As described in the second modification described above, because the remover according to aspect 3 constantly contacts the image bearer, the aspect 3 provides the process cartridge including the remover that scrapes the adhered substance on the image bearer stably.

Aspect 4

In the process cartridge according to the aspect 1, the remover such as the adhered substance removers 501a and 501b is elastically deformable, and configured to be pressed toward the image bearer to contact the image bearer by a pressing member such as a compression spring in the image forming apparatus or the process cartridge. Additionally, when the remover contacts the image bearer by being pressed, the first contact portion 512e of which contact portion considered a plurality of connected lines firstly contacts the image bearer, and deforms elastically. After the deformation, the remover and the image bearer become a contact condition.

As described in the second modification described above, because the remover according to aspect 4 constantly contacts the image bearer, the aspect 4 provides the process cartridge including the remover that scrapes the adhered substance on the image bearer stably.

Aspect 5

In the process cartridge according to the aspect 1, the angle of the gradient 512d of the adhered substance removers 501a and 501b at the contact portion is set greater than 0° and equal to or smaller than 5°. In the aspect 5, as described in the above described the first embodiment, setting the angle of the gradient 512d greater than 0° prevents the contact of the photoconductor 1 and the contact portion from becoming plane contact. Setting the angle of the gradient 512d smaller than or equal to 5° makes it easy for the contact portion to deform elastically and contact the photoconductor 1. Setting the angle of the gradient 512d greater than 5° increase the average distance between the gradient 512d and the photoconductor 1 and the force to contact the photoconductor 1.

Aspect 6

In the process cartridge according to the aspect 1, Material of the remover such as the adhered substance removers 501a and 501b is polyacetal resin.

In the aspect 6, as described in the above described the first embodiment, Use of polyacetal resin that is excellent in sliding property decreases wear of the image bearer contacting the remover, extends a life of the image bearer, improves performance of removing the adhered substance and residual toner.

Aspect 7

In the process cartridge according to the aspect 1, the process cartridge 10 detachably mountable relative to an image forming apparatus 100. The image forming apparatus 100 includes an optical writing head 61 to form the latent image on the image bearer. The remover such as the adhered substance removers 501a and 501b includes a surface that contacts the optical writing head and another surface that contacts the image bearer to regulate a gap between the optical writing head and the image bearer. As described in the above-described first embodiment, the aspect 7 provides the process cartridge that is small and cost effective, and gives stable image quality for a long time because the remover functions as the regulation member. In other words, the aspect 7 is helpful for decreasing a number of parts of the process cartridge (image forming section) and making the image forming apparatus smaller and cost effective.

Aspect 8

Aspect 8 is the image forming apparatus including the process cartridge according to aspect 1.

In the aspect 8, as described in the above-described the first embodiment, the first modification, and the second modification, the image forming apparatus exhibits the benefit of the process cartridge of the aspect 1. Additionally, when the image forming apparatus includes the exposure device of aspect 7, the process cartridge becomes smaller. Therefore, the smaller image forming apparatus is provided.

What is claimed is:

1. A process cartridge, comprising:
an image bearer;
a developer bearer to supply a latent image on the image bearer with toner and develop the latent image;
a cleaner to clean residual toner on the image bearer after a transfer process; and
a remover to contact an end portion of the image bearer in an axial direction of the image bearer,
the remover including an inclined part extending in the axial direction of the image bearer from an upstream side to a downstream side in a direction of movement of the image bearer, the inclined part including a contact portion to contact the image bearer,
the contact portion of the inclined part forming a gradient in the axial direction.

2. The process cartridge according to claim 1,
wherein the gradient of the contact portion in the axial direction comprises a plurality of gradient parts.

3. The process cartridge according to claim 1,
wherein the remover is elastically deformable and configured to be pressed toward the image bearer to contact the image bearer by a pressing member, and
wherein, when the pressing member contacts the remover to the image bearer, the contact portion contacts the image bearer firstly at one line of the contact portion and then deforms elastically.

4. The process cartridge according to claim 1,
wherein the remover is elastically deformable and configured to be pressed toward the image bearer to contact the image bearer by a pressing member, and
wherein, when the pressing member contacts the remover to the image bearer, the contact portion contacts the image bearer firstly at a plurality of connected lines of the contact portion and then deforms elastically.

5. The process cartridge according to claim 1,
wherein the gradient of the contact portion has an angle greater than 0° and equal to or smaller than 5°.

6. The process cartridge according to claim 1,
wherein a material of the remover is polyacetal resin.

7. The process cartridge according to claim 1,
wherein the process cartridge is detachably mountable relative to an image forming apparatus that includes an optical writing head to form a latent image on the image bearer, and
wherein the remover includes a first surface to contact the optical writing head and a second surface to contact the image bearer to regulate a gap between the optical writing head and the image bearer.

8. An image forming apparatus comprising the process cartridge according to claim 1.
